(19) United States
(12) Patent Application Publication
(10) Pub. No.: US 2003/0072279 A1
(43) Pub. Date: Apr. 17, 2003

(54) Power control during compressed mode

(75) Inventors: Seppo Hamalainen, Espoo (FI); Tero Henttonen, Espoo (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corpration, Espoo (FI)

(21) Appl. No.: 09/977,578

(22) Filed: Oct. 15, 2001

(51) Int. Cl. H04Q 7/00

(52) U.S. Cl. 370/332; 370/331

(57) ABSTRACT

A method and apparatus are provided for implementing a compressed mode of operation in a mobile communication network in which data transmission and reception is ceased so a required measurement can be made, wherein the power level of data transmission is adjusted to a correct power level before a subsequent data transmission is sent. The compressed mode may be implemented using a single frame method, in which control channels and power control commands are sent in the last slots of a single frame. The compressed mode may also be implemented using a double frame method, in which control channels and power control commands are sent in the beginning slots of a second frame. The method is implemented during a hard handover procedure, such as an intersystem handover. The measurement includes an inter-frequency measurement.

### BACKGROUND OF THE INVENTION

1. Field of Invention

The present invention relates to a mobile communication network; and more particularly to power control during a compressed mode of data transmission between user equipment (UE) and one or more base stations in a code division multiple access (CDMA) network.

2. Description of Related Art

Generally, in a mobile communication network, when a mobile terminal (or any UE for that matter) travels from one geographic area to another, the mobile telephone may have to be handed over during what is known as a handover procedure from one cell to another in a radio access network, or from one radio access network to another radio access network. During the handover procedure, the mobile telephone needs to do measurements on other frequencies of certain parameters of one or more neighboring radio access networks to which it may soon be handed over. In order to do such handover measurements, some mobile terminals have dual receivers, one receiver for continuous transmission/reception with the radio access network in which it is presently operating, and another receiver for taking the measurements of the certain parameters of the neighboring radio access networks. However, since receivers are expensive, most mobile terminals have only one receiver. In one receiver mobile terminals, handover measurements need to be done by placing the mobile terminal in what is known as a compressed mode of operation, which is often also referred to as a slotted mode.

In particular, the compressed mode is needed when making measurements on another frequency in a CDMA system, or doing measurements in a GSM or other system while having a call going-on in a CDMA network, without a full dual receiver terminal. During the compressed mode of operation, the transmission and reception in the mobile terminal are halted for a short time, in the order of a few milliseconds, in order to perform the measurements on the other frequencies. In effect, transmission and reception are ceased for one or more slots in one or more communications frames. The intention is not to lose data but to compress frames of the data transmission in the time domain, which opens a gap in one or more frames. Single and double frame methods for implementing the compressed mode of operation are known in the art. In one such method, the data rate is increased by changing the spreading factor, as described in WCDMA for UMTS, Radio Access for Third Generation Mobile Communications, edited by H. Holma et al., Wiley & Sons, Ltd. 2000. In order to transmit data at a higher rate, the power used for the data transmission must be increased in the compressed mode. After the gap, the power level must be readjusted for normal operation. However, the gap in a compressed frame distorts the closed loop power control of the mobile terminal. Such distortion further leads to increased frame error rate (FER) and block error rate (BLER). After the gap, transmission powers in the mobile terminal may be at the wrong levels, which can adversely affect the whole transmission time interval (TTI). This is the case especially for mobile terminals moving at moderate speeds in the radio access network.

In an attempt to address this problem, in the prior art a larger power control step is used after the gap to try to adjust the power to appropriate level as soon as possible. However, it may take several power control adjustments before power levels are correct. During that time, data traffic being sent may be distorted.

The invention provides a solution to the aforementioned problem in the prior art.

### SUMMARY OF INVENTION

In its broadest sense, the present invention provides a new and unique method and apparatus for implementing a compressed mode of operation in a mobile communication network in which data transmission and reception in the user equipment is ceased so required measurements can be done. The method and apparatus feature a step or a module for adjusting the power level of data transmission in the user equipment to a correct power level before a subsequent data transmission is sent. In other words, transmission power is adjusted after the transmission/reception gap and before the subsequent data transmission is resumed. During the power adjustment, control channels may be sent, if necessary.

The compressed mode may be implemented using a single frame method, in which transmission is ceased, measurements are made and power levels are adjusted in slots in a single frame. In this case, control channels and power control commands are sent in the last slots of the single frame. Alternatively, the compressed mode may be implemented using a double frame method, in which transmission is ceased and measures are made in slots in a first frame, or in slots between two frames, and power levels are adjusted in slots in a second frame. In effect, in the present invention, no data traffic is sent after a compressed mode gap, instead only control channels and power control are active over this time period. This is done in order to adjust power levels after the gap to a correct level before sending any subsequent data. When power levels are adjusted to the correct level before any data is sent, this reduces the probability of frame error rate (FER) and block error rate (BLER) and thus improves overall system performance.

### BRIEF DESCRIPTION OF THE DRAWING

The drawing, not drawn to scale, includes the following Figures:

FIG. 1 is a diagram of a mobile communication network that forms the subject matter of the present invention.

FIGS. 2A and 2B are diagrams of a compressed mode scheme using a single frame method.

FIG. 3 is a graph showing power (dB) versus time using the single frame method shown in FIG. 2A.

FIG. 4 is a flowchart of steps for implementing the single frame method shown in FIG. 2A.

FIGS. 5A, 5B, 5C, 5D and 5E are diagrams of a compressed mode scheme using double and triple frame methods.

FIG. 6 is a graph showing power (dB) versus time using the double frame method shown in FIG. 5A.

FIG. 7 is a flowchart of steps for implementing the double frame method shown in FIG. 5A.

FIG. 8 is a diagram of user equipment in the mobile communication network shown in FIG. 1.

FIG. 9 is a diagram of a user equipment handover procedure module that forms part of the user equipment shown in FIG. 8.

FIG. 10 is a diagram of a radio network controller in the mobile communication network shown in FIG. 1.

### DETAILED DESCRIPTION OF INVENTION

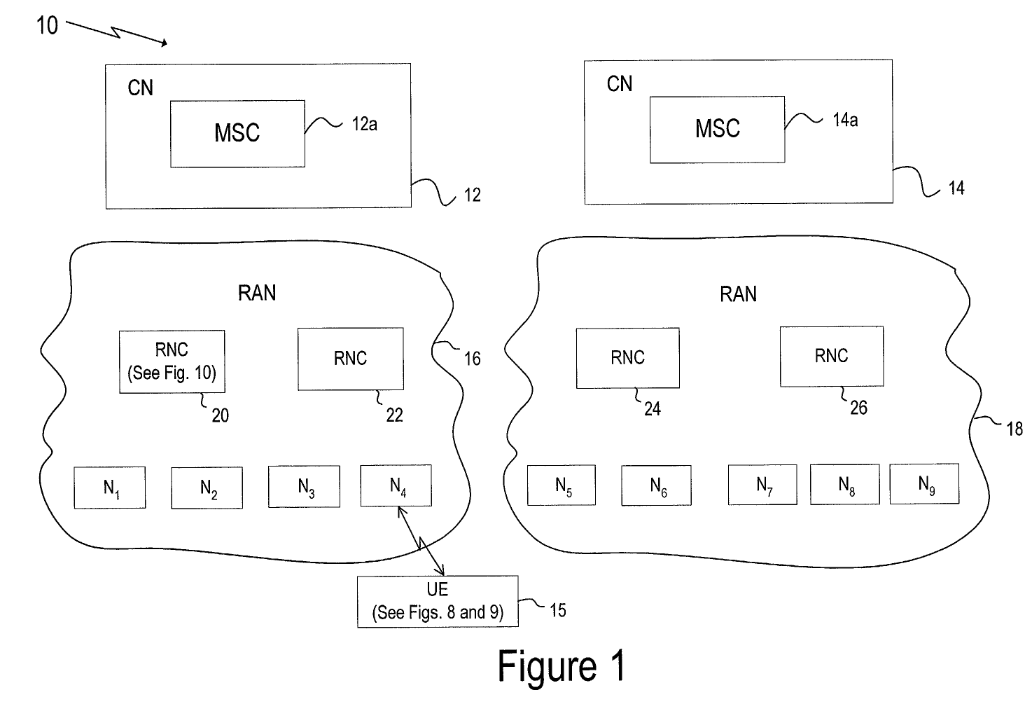

### FIG. 1: The Basic Invention

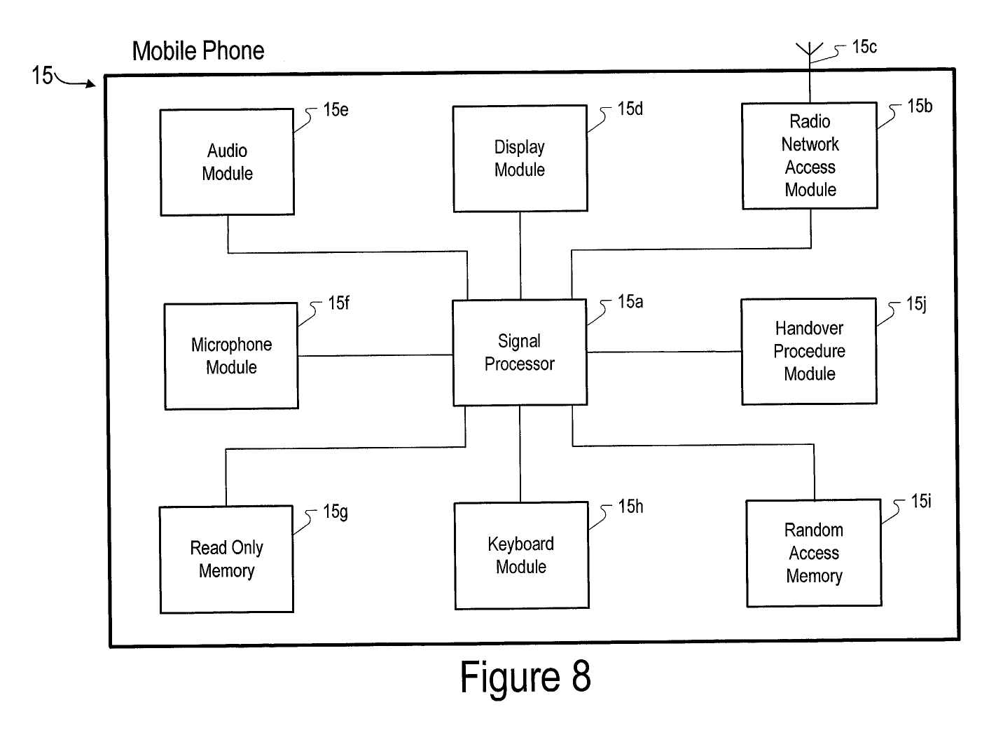

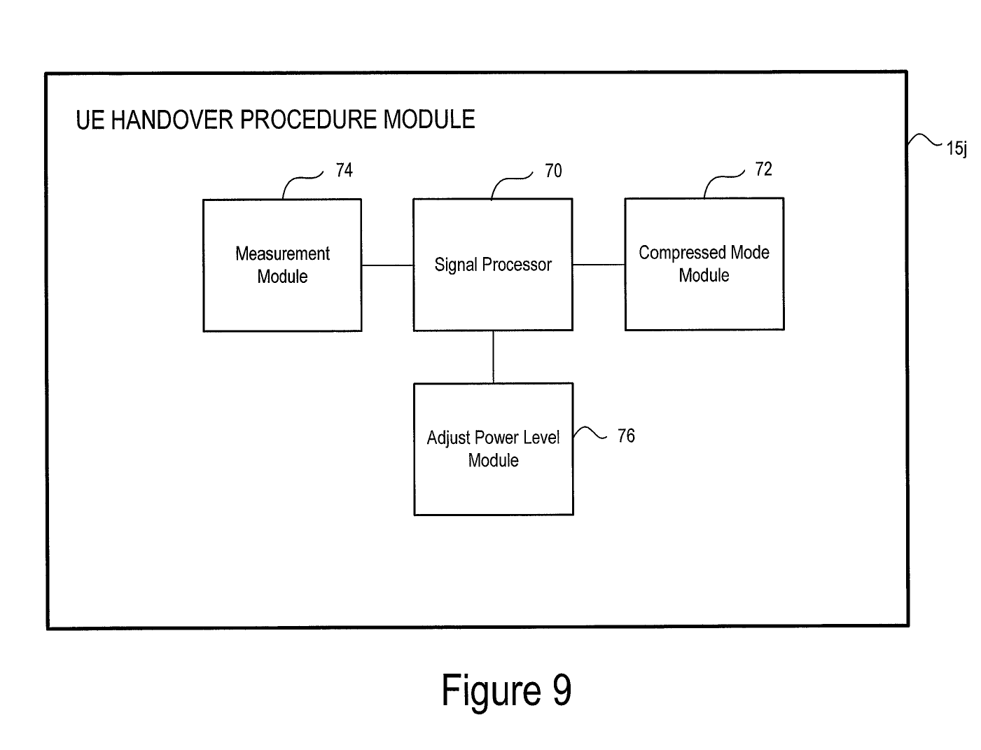

FIG. 1 shows a mobile communication network generally indicated as 10, which forms a part of a WCDMA network. (The scope of the invention is intended to include the mobile communication network 10 forming a part of other mobile communication networks known in the art.) The mobile communication network 10 includes two core networks (CN) 12, 14, two radio access networks (RAN, RAN) 16, 18 and one or more mobile terminals 15, which are also known and referred to herein as user equipment (UE). The UE 15 is shown and described in more detail in relation to FIGS. 8-9.

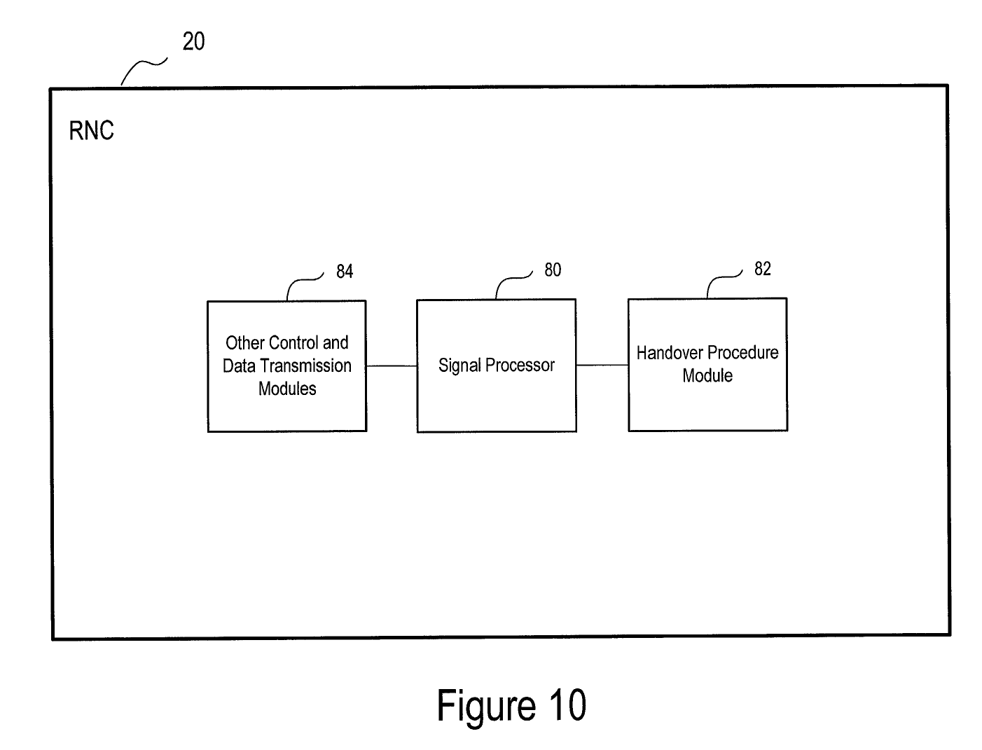

Each CN 12, 14 has a mobile service switching center (MSC) 12a, 14a and is coupled to a respective RAN 16, 18. The CN 12, 14 and MSC 12a, 14a are known in the art. The RAN 16 has two RNCs 20, 22, each for covering a respective geographic area. The RNCs 20, 22 are shown and described in more detail in relation to FIG. 10.

One RNC 20 is coupled to two nodes N₁, N₂. The other RNC 22 is coupled to two nodes N₃, N₄. Similarly, the RAN 18 has two RNCs 24, 26. One RNC 24 is coupled to three nodes N₅, N₆, N₇. The other RNC 26 is coupled to nodes N₈, N₉. In FIG. 1, each node N₁ through N₇ is also referred to in the art as a node B or a base station, and is known in the art.

The UE 15 is coupled via a radio interface to node N₄. As shown, the UE 15 is moving from the geographic area covered by the RNC 16 to the geographic area covered by the RNC 18. This UE movement will cause a compressed mode of operation to be invoked during a handover procedure by the RNC 22 in order to handover the UE 15 from node N₄ in the RAN 16 to node N₅ in the RAN 18 if the two networks operate at different frequencies. The present invention provides a new method and apparatus for implementing the compressed mode of operation in the mobile communication network 10 in which data transmission and reception in the UE 15 is ceased so a required measurement can be made, wherein the power level of data transmission in the UE 15 is adjusted to a correct power level before a subsequent data transmission is sent.

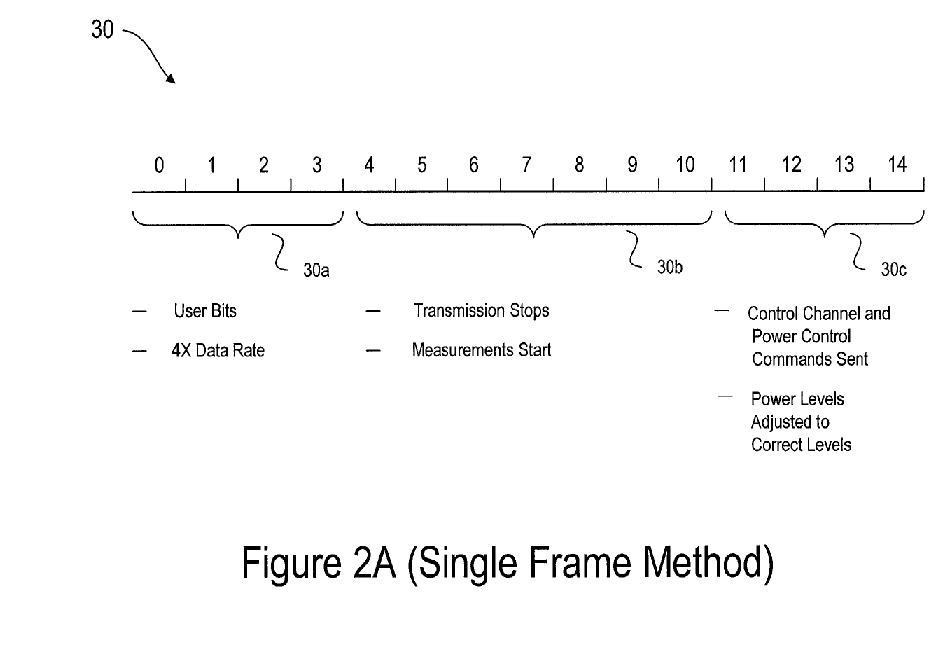

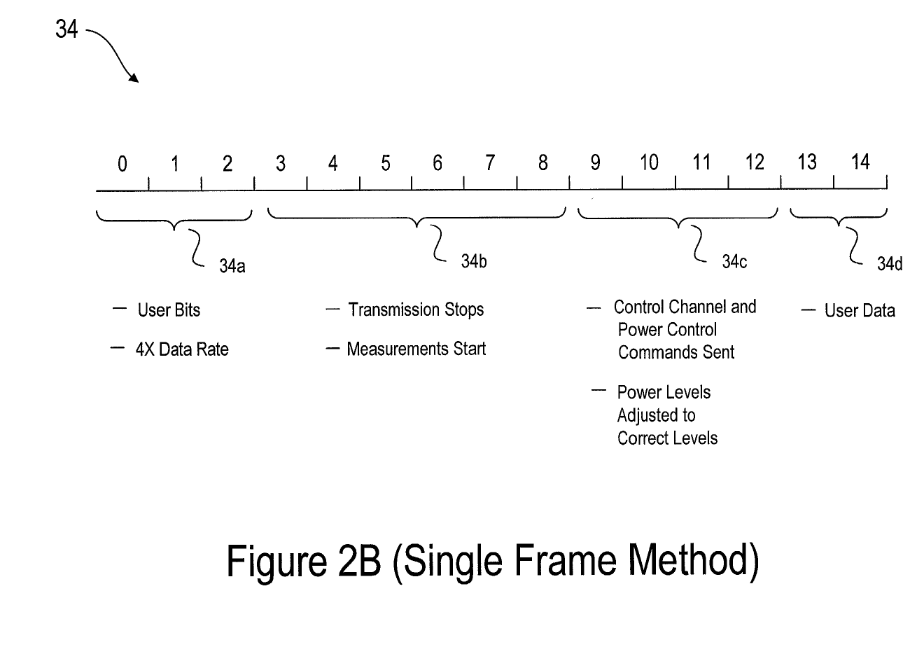

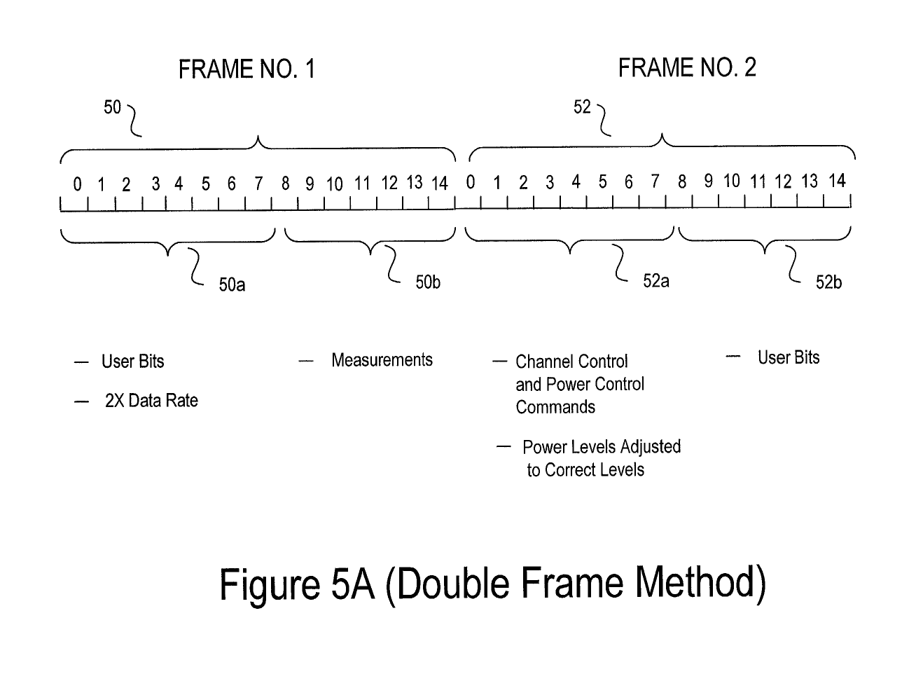

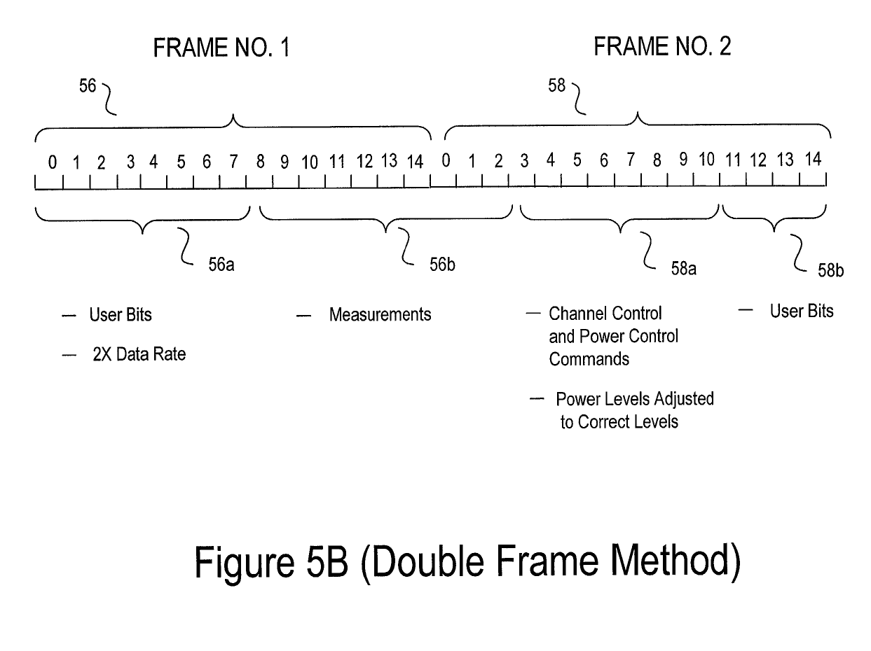

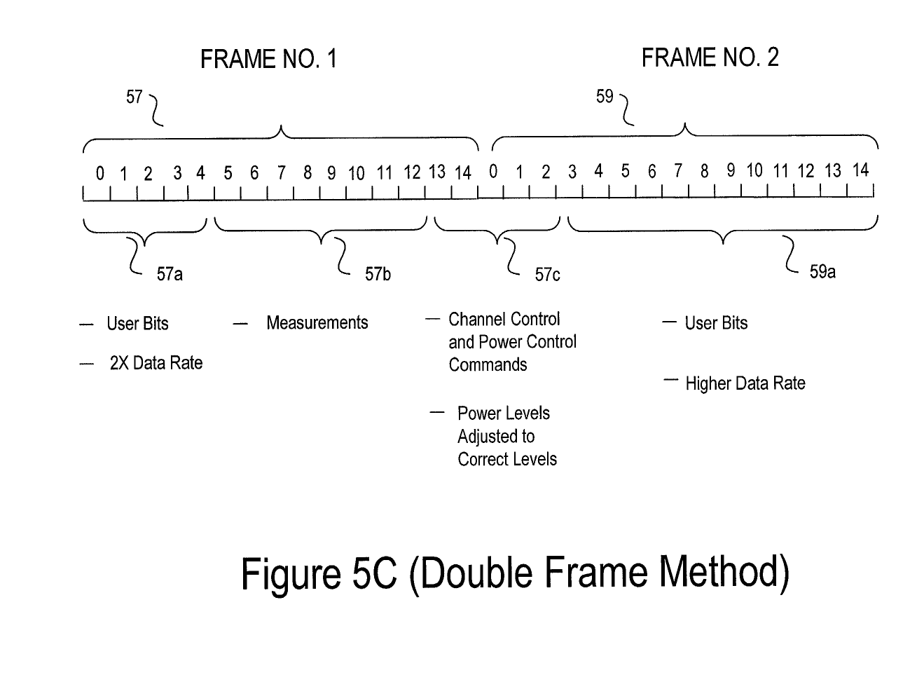

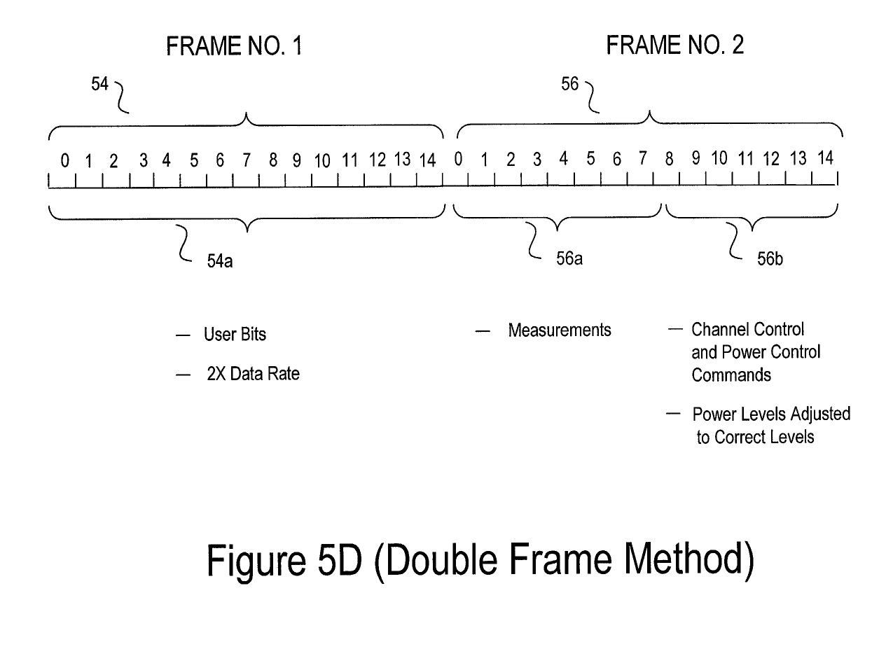

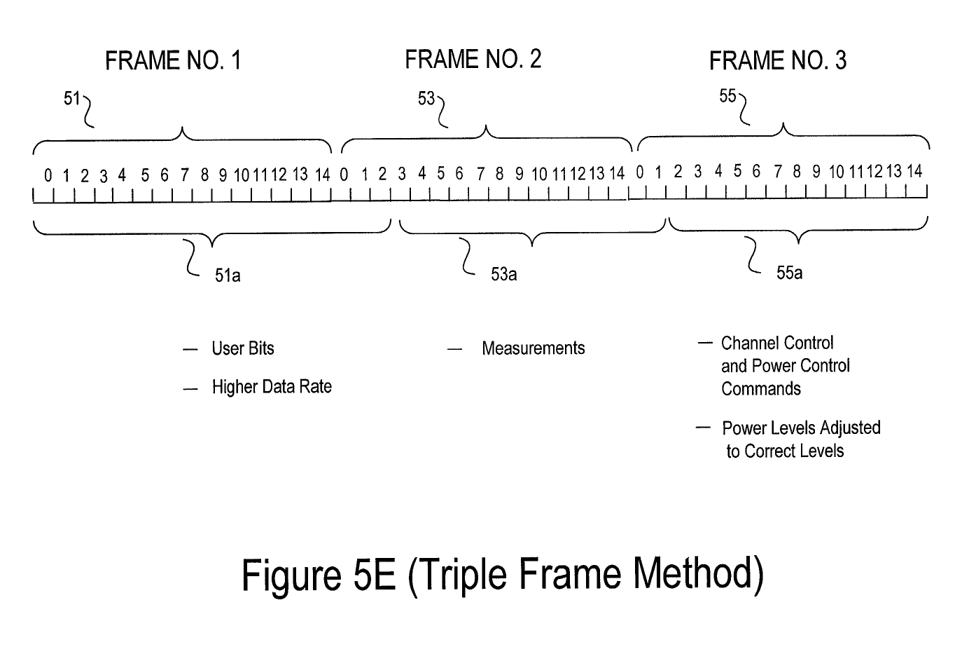

The compressed mode of operation may be implemented using a single frame method, in which control channels and power control commands are sent in the last slots of a single frame, as described below in relation to FIGS. 2A-4. Alternatively, the compressed mode may be implemented using a double frame method, in which control channels and power control commands are sent in slots of a second frame, as described below in relation to FIGS. 5A-7.

### FIGS. 2A-4: The Single Frame Method

FIGS. 2A-4 show the compressed mode of operation using the single frame method.

In general, in the single frame method compressed mode data transmission is sent in the beginning X slots of a single frame; the data transmission and reception is ceased in the intermediate Y slots of the single frame and one or more measurements are made during this transmission gap; and the control channels and power control commands are only sent in the remaining 15-X-Y slots of the single frame to adjust the power level of the data transmission in the next frame.

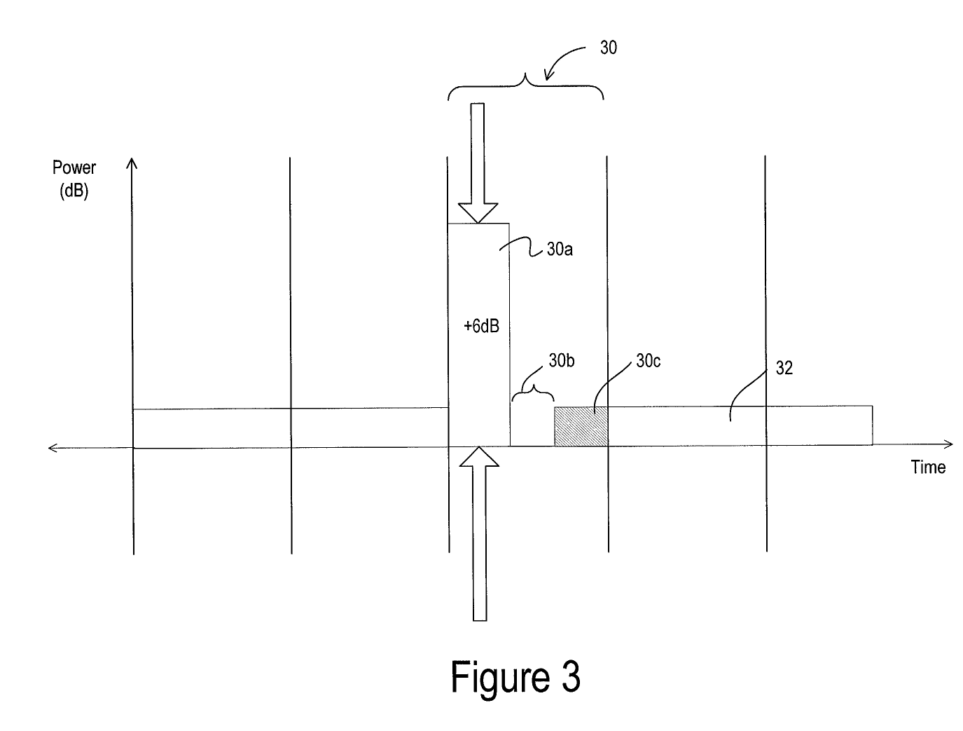

By way of example, FIGS. 2A and 3 show a single frame of data generally indicated as 30 having 15 slots labelled 0-14. In this example, the parameter X=4 and the parameter Y=7. In frame section 30a, user bits are transmitted during the beginning four slots (i.e. slots 0-3), for example, with a 4-fold data rate, which leads to a 6 dB lower processing gain and a 6 dB higher transmission power. During the intermediate seven slots (i.e. slots 4-10) in frame section 30b, transmission and reception is ceased and one or more measurements are made during cessation in the transmission and reception. The measurements may include one or more frequency measurements, synchronization and signaling with other networks, as well as other types of measurements described in more detail below. During the remaining four slots (i.e. slots 11-14) in frame section 30c, only control channels and power control commands are sent. The power level used may be the same as it was in the frame before the gapped frame 30b, or higher or lower power may be used depending on the circumstance. During slots 11-14 in frame section 30c, power levels are adjusted to the correct level as shown in frame 32 (FIG. 3).

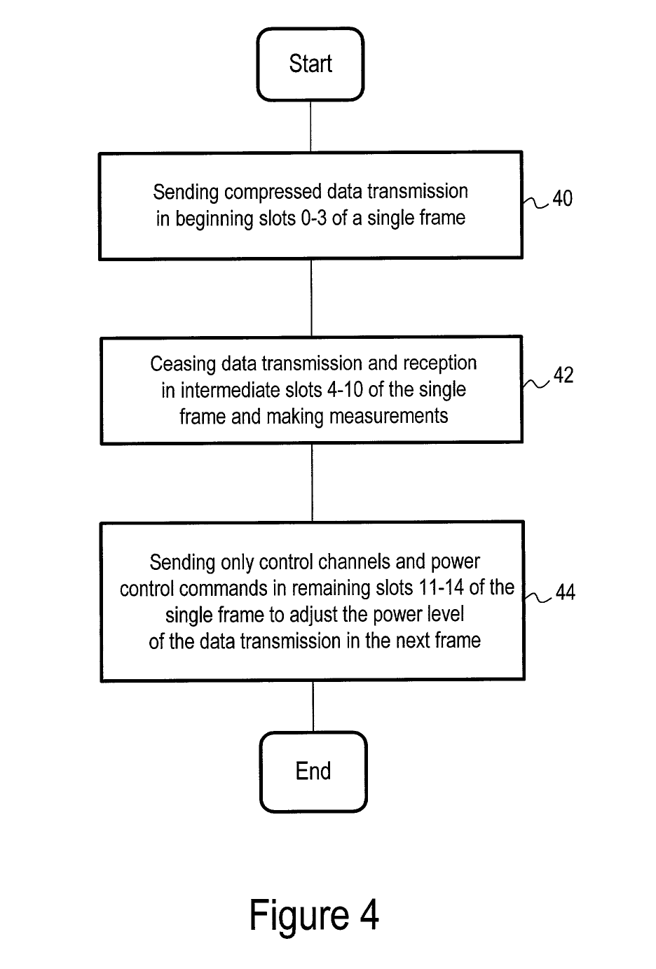

FIG. 4 shows a flowchart of the single frame method shown by way of example in FIGS. 2A and 3, which has three steps 40, 42, 44, including: (1) a first step 40 for sending compressed data transmission in slots 0-3 in frame section 30a of the single frame 30; (2) a second step 42 for ceasing data transmission and reception in slots 4-10 in frame section 30b of the single frame 30 and making measurements; and (3) a third step 44 for sending only the control channels and power control commands in slots 11-14 in frame section 30c of the single frame 30 to adjust the power level of the data transmission in the next frame 32.

In an alternative single frame method, the compressed data transmission may be sent during X beginning slots, transmssion/reception cessation and measurements are performed during the following Y slots, power control adjustment is made during the following Z slots, and the subsequent data is sent during the remaining 15-X-Y-Z slots. FIG. 2B shows the alternative single frame method for the case where X=3, Y=6 and Z=4, implemented for a single frame of data generally indicated as 30 having 15 slots labelled 0-14. In frame section 34a, user bits are transmitted during the first 3 slots (i.e. slots 0-2), for example, with a 4-fold data rate, which leads to a 6 dB lower processing gain and a 6 dB higher transmission power. During the next six slots (i.e. slots 3-8) in frame section 34b, transmission and reception is ceased and one or more measurements are made during cessation in the transmission and reception. The measurements may include one or more frequency measurements, as well as other types of measurements described in more detail below. During the next 4 slots (i.e. slots 9-12) in frame section 34c, only control channels and power control commands are sent. The used power level is the same as it was in the frame before the gapped frame 34b. During slots 9-12 in frame section 34c, power levels are adjusted to the correct level. During the remaining 2 slots (i.e. slots 13-14) in frame section 34d, subsequent data transmission is sent.

The scope of the invention is not intended to be limited to any particular number of slots used for the compressed data transmission, transmission/reception cessation and measurements or power level adjustment.

Moreover, the scope of the invention is not intended to be limited to the order of performing compressed data transmission in relation to transmission/reception cessation and measurements. For example, embodiments are envisioned in which the transmission/reception cessation and measurements are performed in beginning slots of the single frame, compressed data transmission sent in intermediate slots of the single frame, and power level adjustment performed in the remaining slots of the single frame. In this example, the use of the slots in the single frame may be configured so subsequent data may also be sent after the power level adjustment.

### FIGS. 5A-7: The Double Frame Method

FIGS. 5A through 7 show the compressed mode of operation using the double frame method.

In general, in a first type of double frame method compressed mode data transmission is sent in the beginning X slots of a first frame, the data transmission and reception is ceased in the remaining 15-X slots of the first frame and measurements are made during this transmission gap, the control channels and power control commands are only sent in the beginning Y slots of the second frame to adjust the power level of the data transmission in the second frame, and the subsequent data transmission is sent in the remaining 15-Y slots of the second frame.

Alternatively, in a second type of double frame method, the compressed mode data transmission may be sent in the beginning X slots of the first frame, the data transmission and reception is ceased in the remaining 15-X slots of the first frame and beginning Y slots of the second frame and one or more measurements are made during this transmission gap, the control channels and power control commands are only sent in the intermediate Z slots of the second frame to adjust the power level of the data transmission in the second frame, and the subsequent data transmission is sent in the remaining 15Y-Z slots of the second frame with higher power.

Alternatively, in a third type of double frame method compressed mode data transmission is sent in the beginning X slots of a first frame, the data transmission and reception is ceased in the next Y slots of the first frame and measurements are made during this transmission gap, and the control channels and power control commands are sent in the following Z slots overlapping both the first and second frames to adjust the power level of the data transmission in the second frame. The power control period length which overlaps the second frame is mod((X+Y+Z), 15), and the subsequent data transmission is sent in the remaining 15−mod((X+Y+Z), 15) slots of the second Frame.

Alternatively, in a fourth type of double frame method compressed mode transmission is sent in a first frame, the data transmission and reception is ceased and measurements being made in beginning slots of a second frame, and control channels and power control commands are sent in remaining slots of the second frame.

Embodiments are also envisioned in which more than two frames are used, in which either compressed data transmission, transmission/reception cessation and measurements, power level adjustments, or a combination thereof are sent over multiple frames. For example, in the case where three frames are used compressed data transmission may be sent during beginning slots of a first frame, transmission/reception cessation and measurements may be performed in the remaining slots of the first frame and beginning slots of a second frame, power level adjustment may performed in the remaining slots of the second frame and beginning slots of a third frame, and subsequent data transmission may be sent in the remaining slots of the third frame.

Moreover, consistent with that discussed above in relation to the single frame method, the scope of the invention is not intended to be limited to the order of performing compressed data transmission in relation to transmission/reception cessation and measurements. For example, embodiments are envisioned in which the transmission/reception cessation and measurements are performed first and the compressed data transmission sent after the transmission/reception cessation and measurements.

The scope of the invention is not intended to be limited to any particular number of slots used for the compressed data transmission, transmission/reception cessation and measurements or power level adjustment.

### The First Type of Double Frame Method

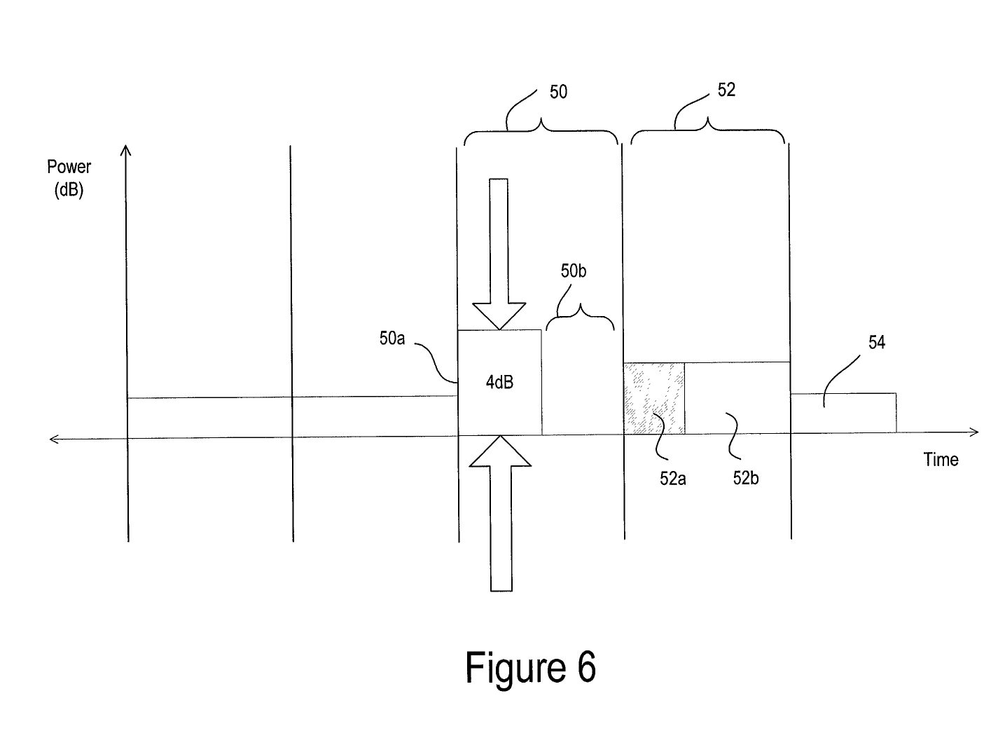

In particular, and by way of example, FIGS. 5A and 6 show one double frame method with double frames of data generally indicated as 50, 52, each having 15 slots labelled 0-14. In this example, the parameter X=8 and the parameter Y=8 for the first type of double frame method discussed above. In frame section 50a of the first frame 50, user data is sent during the beginning eight slots (i.e. slots 0-7) with a 2-fold data rate (3 dB lower PG, 3 dB higher TxP). During the remaining seven slots (i.e. slots 8-14) in frame section 50b, one or more frequency measurements are made during the transmission gap. During the beginning eight slots in frame section 52a of the second frame 52, only control channels and power control are active. During this time, power levels are adjusted to a correct level. During the remaining seven slots in frame section 52b of the second frame 52, user data is sent with a 15/(15−x) times higher data rate. The frame section 52b is shown in FIG. 6 as having the same power level as frame section 52a, although they do not necessarily have to have the same power level. Also processing gain and transmission powers are altered. During the third frame 54, normal data rate, processing gain and power are used.

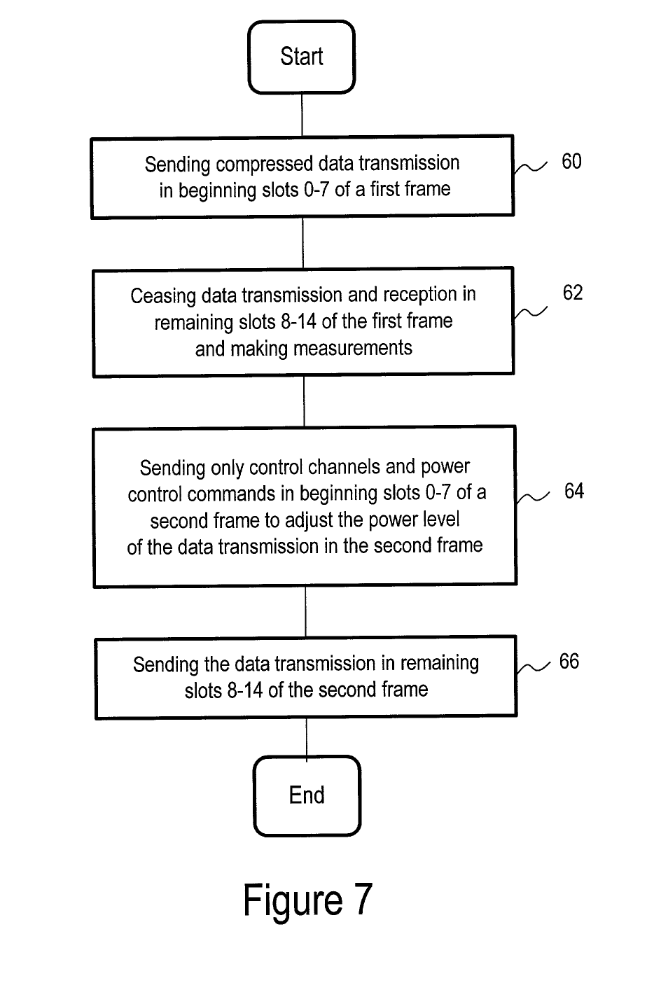

FIG. 7 shows a flowchart of the double frame method shown by way of example in FIG. 5, which has four steps 60, 62, 64, 66, including: (1) a first step 60 for sending compressed data transmission in the beginning eight slots in frame section 50a of the first frame 50; (2) a second step 62 for ceasing data transmission and reception in the remaining seven slots in frame section 50b of the first frame 50; (3) a third step 64 for only sending the control channels and power control commands in slots 1-N in frame section 52a of the second frame 52 to adjust the power level of the data transmission in the second frame 52; and (4) a fourth step 66 for sending the subsequent data transmission in the remaining slots in frame section 52b of the second frame 52.

The scope of the invention is also intended to include embodiments in which data is transmitted with a double bit rate during the first frame, while during the following frame no data is transmitted, and in the beginning of the second frame, measurements are made, then in the latter part of that frame, power control is adjusted.

### The Second Type of Double Frame Method

By way of another example, FIG. 5B shows an alternative double frame method in which the transmission gap overlaps the two frames. The double frames generally indicated as 56, 58, each having 15 slots labelled 0-14. In this embodiment, the parameter X=8, the parameter Y=3, and the parameter Z=8 in the second type of double frame method discussed above. In frame section 56a of the first frame 56, user data is sent during the beginning eight slots (i.e. slots 0-7) of the first frame 56 with a 2-fold data rate (3 dB lower PG, 3 dB higher TxP). During the remaining seven slots (i.e. slots 8-14) in frame section 56b of the first frame 56 and the beginning three slots (i.e. slots 0-2) frame section 58a of the following frame 58 data transmission is ceased and one or more frequency measurements are made during the transmission gap. During intermediate slots (i.e. slots 3-10) in frame section 58a of the following frame 58, only control channels and power control are active. During this time, power levels are adjusted to a correct level. During remaining slots 11-14 in frame section 58b of the second frame 58, user data is subsequently sent. The frame section 58b may have the same power level as frame section 58a, although they do not necessarily have to have the same power level.

### The Third Type of Double Frame Method

FIG. 5C shows a double frame method that is an alternative to the single frame method shown and described in relation to FIG. 2B. In this example, the power control period in frame section 57c of frame 57, which lasts z slots for z=5, can be expanded to last into the next frame 59, and the remaining slots in frame section 59a of the next frame 59 (after the gapped frame) may be transmitted with a higher bit rate. As shown, data is sent during the beginning x slots for x=5 in frame section 57a, the transmission gap and measurements last for the next y slots for y=8 in frame section 57b, the power control adjustment period follows in the next z slots for z=5 in frame section 57c that bridges frames or overlaps 57 and 59. Similar to that discussed above, the power control period length which overlaps the second frame is mod((X+Y+Z), 15). Since X+Y+Z>15, the power control adjustment period is done after the transmission gap in the remaining two slots in frame section 57c of the first frame 57 and during the beginning three slots in frame section 57c of the next frame 59. After the power control adjustment period, data is sent with the higher bit rate during the remaining 15−mod((X+Y+Z), 15) slots of the second frame 59, where mod(x, n) means the remainder of the division (X+Y+Z)/15. For example, mod(7, 2)=1, since 7/2=3*2+1. (For the case where X+Y+Z=15, the power control adjustment period is done after the transmission gap in the remaining slots in frame section 57c of the first frame 57, and after the power control adjustment period, data is sent with a higher bit rate during the beginning slots in the next frame 59, similar to the single frame method shown in FIG. 2A.)

### The Fourth Type of Double Frame Method

FIG. 5D shows the fourth type of double frame method in which compressed mode transmission is sent in a first frame 54, the data transmission and reception is ceased and measurements being made in beginning slots in frame section 56a of a second frame 56, and control channels and power control commands are sent in remaining slots in a frame section 56b of the second frame 56.

### A Method Using Three or More Frames

By way of example, FIG. 5E shows a three frame method. The three frames are generally indicated as 51, 53, 55, each having 15 slots labelled 0-14. In frame section 51a overlapping the frames 51, 53, the compressed data transmission is sent during the first frame 51 and beginning slots of a second frame 53. In frame section 53a overlapping the frames 53, 55, the transmission/reception cessation and measurements are performed in the remaining slots of the second frame 53 and beginning slots of the third frame 55. In frame section 55a of the frame 55, the power level adjustment is performed in the remaining slots of the third frame 55. Embodiments are also envisioned in which the power level adjustment is completed before the end of the third frame 55, and the subsequent data transmission is sent in the remaining slots of the third frame 55.

The scope of the invention is intended to include embodiments in which the compressed data transmission is completed in the first frame, and the transmission/reception cessation or measurements power level adjustment overlaps the first and second frames. The scope of the invention is also intended to include embodiments in which the compressed data transmission and the transmission/reception cessation or measurements power level adjustment are completed in the first frame, and the power level adjustment overlaps the first and second frames, as well as the second and third frames. The scope of the invention is also intended to include embodiments in which the transmission/reception cessation and measurements are performed before the compressed data transmission.

The scope of the invention is intended to include embodiments using more than three frames in a manner consistent with that described above.

### FIG. 8: User Equipment

FIG. 8 shows in more detail the user equipment in the form of the mobile phone 15. The scope of the invention is also intended to cover other user equipment and mobile electronic devices, such as a laptop or portable computer.

The mobile phone 15 includes a signal processor 15a connected to a radio access network module 15b (connected to an antenna 15c), a display module 15d, an audio module 15e, a microphone 15f, a read only memory 15g (ROM or EPROM), a keyboard module 15h and a random access memory 15i (RAM). The signal processor 15a controls the operation of mobile phone 15, the operation of which is known in the art. Moreover, the scope of the invention is not intended to be limited to any particular kind or type of the aforementioned elements 15a, 15b, . . . , 15i. For example, the scope of the invention is intended to include the radio access network module 15b being either an antenna module, a radio frequency (RF) module, a radio modem or the like. The UE 15 may also include many other circuit elements known in the art which are not shown or described.

The signal processor 15a is also connected to a handover procedure module 15j. The whole thrust of the invention relates to the operation of the handover procedure module 15j in order to handover the UE 15 from node N₄ in the RAN 16 to node N₅ in the RAN 18. In operation, the mobile phone 15 responds to an initiate handover procedure signal from the RNC 22 (FIG. 1) and implements a series of steps needed to make a successful handover. The handover may include, for example, a hard handover, an intersystem handover, or a handover that is made between two wideband code division multiple access networks, between frequency division duplex and time division duplex modes, and between a wideband code division multiple access network and another network such as a GSM network; and the scope of the invention is not intended to be limited to any particular type of handover.

### FIG. 9: UE Handover Procedure Module

FIG. 9 shows in more detail the UE handover procedure module 15j having a signal processor 70, a compressed mode module 72, a measurement module 74, and an adjust power level module 76, which all form part of the present invention.

The signal processor 70 controls the operation of the UE handover procedure module 15j.

The compressed mode module 72 cooperates with one or more of the RNCs 20, 22, 24, 26 (FIG. 1) to implement the compressed mode using a single frame method, and send control channels and power control commands in the last slots of a single frame, such as frame 30 in FIGS. 2-3. In operation, the compressed mode module 72 sends compressed mode data transmission in the beginning four slots in frame section 30a of the single frame 30 (FIGS. 2-3) and ceases the data transmission and reception in the next seven slots in frame section 30b of the single frame 30. The measurement module 74 makes one or more frequency measurements during the cessation in transmission/reception. By way of example, other types of measurement may also include power level measurements, initial synchronization measurements to a frequency correction channel and a synchronization channel, and tracking measurements of the frequency correction and synchronization channels and base station identity code decoding, which are all known in the art. The adjust power level module 76 only sends the control channels and power control commands are only sent in the remaining four slots in frame section 30c of the single frame 30 to adjust the power level of the subsequent data transmission in the next frame consistent with that described above.

The signal processor 70, the compressed mode module 72, the measurement module 74 and the adjust power level module 76 may be implemented using hardware, software or a combination thereof. In a software embodiment, a typical microprocessor-based design may be used. As a person skilled in the art would appreciate, the microprocessor-based design would typically include a more expensive processor, ROM, RAM, input/output and data and address lines for coupling the same. The scope of the invention is not intended to be limited to any particular software implementation of these modules. A person skilled in the art after reading the application as a whole would appreciate how to implement any of the aforementioned modules in hardware, software, or a combination thereof.

The compressed mode module 72 may also be implemented using a double frame method, in which control channels and power control commands are sent in the beginning slots of a second frame, consistent with that discussed above.

### FIG. 10: Radio Network Controller

FIG. 10 shows, by way of example, the RNC 20 (see also FIG. 1) having a signal processor 80, a handover procedure module 82 and other control and data transmission modules 84. The signal processor 80 controls the operation of the RNC 20. The handover procedure module 82 cooperates with the handover procedure module 15j of the mobile phone 15 (FIGS. 1 and 8) for performing a given handover from one RAN to another RAN. The other control and data transmission modules 84 perform other control and data transmissions which do not form parts of the overall invention.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

For example, the scope of the invention is not intended to be limited to the particular number of frames or slots for sending compressed mode data, ceasing data transmission or reception or adjusting the power level, or the particular processing gain or power for sending the compressed data transmission.

We claim:

1. A method of implementing a compressed mode of operation in a mobile communication network in which data transmission and reception in user equipment is ceased so a required measurement can be made, characterized in that
the power level of data transmission in the user equipment is adjusted to a correct power level before a subsequent data transmission is sent.

2. A method according to claim 1, characterized in that
the compressed mode is implemented using a single frame method.

3. A method according to claim 2, characterized in that
compressed mode data transmission is sent in beginning slots of the single frame, the data transmission and reception is ceased in intermediate slots of the single frame and one or more measurements are made during the transmission gap, and the control channels and power control commands are only sent in the remaining slots of the single frame to adjust the power level of the data transmission in the next frame to the correct level.

4. A method according to claim 1, characterized in that
the compressed mode is implemented using a double frame method, and control channels and power control commands are sent in slots of a second frame.

5. A method according to claim 4, characterized in that
compressed mode data transmission is sent in the beginning slots of a first frame, the data transmission and reception is ceased in the remaining slots of the first frame and measurements are made during the transmission gap, the control channels and power control commands are only sent in the beginning slots of the second frame to adjust the power level of the data transmission in the second frame to the correct level, and the subsequent data transmission is sent in the remaining slots of the second frame.

6. A method according to claim 1, characterized in that the method is implemented during a handover procedure.

7. A method according to claim 6, characterized in that the handover procedure is a hard handover.

8. A method according to claim 6, characterized in that the handover procedure is an intersystem handover between two wideband code division multiple access networks, a handover between frequency division duplex and time division duplex modes, or a handover between a wideband code division multiple access network and another network such as a GSM network.

9. A method according to claim 1, characterized in that the measurement is an inter-frequency measurement.

10. A method according to claim 9, characterized in that
the measurement includes power level measurements, an initial synchronization measurements to a frequency correction channel and a synchronization channel, and tracking measurements of the frequency correction and synchronization channels and base station identity code decoding.

11. User equipment for a mobile communication network having a compressed mode module for implementing a compressed mode of operation in which data transmission and reception is ceased so a required measurement can be made, characterized in that
the user equipment includes an adjust power level module for adjusting the power level of data transmission to a correct power level before a subsequent data transmission is sent.

12. User equipment according to claim 11, characterized in that
the compressed mode module implements the compressed mode using a single frame method.

13. User equipment according to claim 12, characterized in that
the user equipment has a handover module with the compressed mode module, a measurement module and an adjust power level module;
the compressed mode module sends compressed mode data transmission in the beginning slots of the single frame and ceases the data transmission and reception in the intermediate slots of the single frame;
the measurement module makes one or more measurements during the transmission gap; and
the adjust power level module only sends the control channels and power control commands are only sent in the remaining slots of the single frame to adjust the power level of the subsequent data transmission in the next frame.

14. User equipment according to claim 11, characterized in that
the compressed mode module implements the compressed mode using a double frame method, and control channels and power control commands are sent in slots of a second frame.

15. User equipment according to claim 14, characterized in that
the user equipment has a handover module with the compressed mode module, a measurement module and an adjust power level module;
the compressed mode module sends compressed mode data transmission in the beginning slots of a first frame and ceases the data transmission and reception in the remaining slots of the first frame;
the measurement module makes measurements during the transmission gap;
the adjust power level module only sends the control channels and power control commands in the beginning slots of the second frame to adjust the power level of the data transmission in the second frame to the correct level; and
the compressed mode module sends the subsequent data transmission in the remaining slots of the second frame.

16. User equipment according to claim 11, characterized in that the user equipment has a handover procedure module having the compressed module therein for implementing the compressed mode during a handover procedure.

17. User equipment according to claim 16, characterized in that the handover procedure is a hard handover.

18. User equipment according to claim 16, characterized in that the handover procedure is an intersystem handover between two wideband code division multiple access networks, a handover between frequency division duplex and time division duplex modes, or a handover between a wideband code division multiple access network and another network such as a GSM network.

19. User equipment according to claim 16, characterized in that the handover procedure module has a measurement module for making an inter-frequency measurement.

20. User equipment according to claim 19, characterized in that the measurement module makes power level measurements, initial synchronization measurements to a frequency correction channel and a synchronization channel, and tracking measurements of the frequency correction and synchronization channels and base station identity code decoding.

21. A method according to claim 1, characterized in that
compressed mode data transmission is sent in the beginning slots of a first frame, the data transmission and reception is ceased in the remaining slots of the first frame and beginning slots of a second frame and measurements are made during this transmission gap, the control channels and power control commands are only sent in intermediate slots of the second frame to adjust the power level of the data transmission in the second frame to the correct level, and the subsequent data transmission is sent in the remaining slots of the second frame.

22. User equipment according to claim 11, characterized in that
the user equipment has a handover module with the compressed mode module, a measurement module and an adjust power level module;
the compressed mode module sends compressed mode data transmission in the beginning slots of a first frame and ceases the data transmission and reception in the remaining slots of the first frame and beginning slots of a second frame;
the measurement module makes measurements during this transmission gap;
the adjust power level module sends only the control channels and power control commands in intermediate slots of the second frame to adjust the power level of the data transmission in the second frame to the correct level; and
the compressed mode module sends the subsequent data transmission in the remaining slots of the second frame.

23. A method according to claim 1, characterized in that
the compressed mode is implemented using a multiple frame method, and control channels and power control commands are sent in slots of a last frame.

24. User equipment according to claim 11, characterized in that
the compressed mode module implements the compressed mode using a multiple frame method, and sends control channels and power control commands in slots of a last frame.

25. A method according to claim 2, characterized in that
compressed mode data transmission is sent in beginning slots of the single frame, the data transmission and reception is ceased in intermediate slots of the single frame and one or more measurements are made during the transmission gap, the control channels and power control commands are sent in the subsequent intermediate slots of the single frame to adjust the power level of the data transmission to the correct level and subsequent data transmission is sent in the remaining slots of the single frame.

26. A method according to claim 4, characterized in that
compressed mode data transmission is sent in the beginning slots of a first frame, the data transmission and reception is ceased in the intermediate slots of the first frame and measurements are made during the transmission gap, the control channels and power control commands are sent in slots that overlap the first and second frames to adjust the power level of the data transmission in the second frame to the correct level, and the subsequent data transmission is sent in the remaining slots of the second frame.

27. A method according to claim 4, characterized in that
compressed mode data transmission is sent in a first frame, the data transmission and reception is ceased in the beginning slots of the first frame and one or more measurements are made during the transmission gap, and the control channels and power control commands are sent in remaining slots of the second frame to adjust the power level of the data transmission in the second frame to the correct level.

28. A method according to claim 2, characterized in that
power control commands are sent in slots of the single frame.

29. A method according to claim 28, characterized in that
control channel commands are also sent in slots of the single frame.

30. User equipment according to claim 12, characterized in that
the compressed mode module sends power control commands in slots of the single frame.

31. User equipment according to claim 30, characterized in that
the compressed mode module also sends control channel commands in slots of the single frame.

32. A method according to claim 1, characterized in that the compressed more is implemented with a method using three or more frames.

33. A method according to claim 32, characterized in that
compressed data transmission is sent during a first frame and beginning slots of a second frame, transmission/reception cessation and measurements is performed in the remaining slots of the second frame and beginning slots of a third frame, and power level adjustment are performed in the remaining slots of the third frame.
